(19) United States
(12) Patent Application Publication
(10) Pub. No.: US 2015/0244816 A1
(43) Pub. Date: Aug. 27, 2015

(54) PUTTING A PIECE OF EQUIPMENT CONNECTED TO A MULTI-LINK NETWORK ON STANDBY

(71) Applicant: ORANGE, Paris (FR)

(72) Inventor: Pascal Pagani, Guingamp (FR)

(21) Appl. No.: 14/431,580

(22) PCT Filed: Sep. 25, 2013
(86) PCT No.: PCT/FR2013/052251

§ 371 Date: Mar. 26, 2015

(30) Foreign Application Priority Data
Sep. 28, 2012 (FR) 1259233

(51) Int. Cl. H04L 29/08; H04W 36/24

(52) U.S. Cl. CPC H04L 67/145; H04W 36/245; H04W 84/10

(57) ABSTRACT

Disclosed is a management method for putting a piece of communication equipment involved in a plurality of connections between terminal devices of a communication network in standby, the method comprising: detecting that one of the connections is switching from an active state, in which data is transmitted via the connection, to an inactive state, in which no data is transmitted via the connection, keeping the communication equipment switched on if at least one other of the connections is in an active state, and putting the communication equipment on standby if none of the connections is in an active state.

### FIELD OF THE INVENTION

The invention concerns the field of telecommunications and more particularly the placing on standby of communication equipment connected to a network, in particular a local home network when this network is composed of multiple links, the communication equipment possibly being associated with a plurality of connections between terminal devices of the network.

### BACKGROUND OF THE INVENTION

The switching of communication equipment to standby entails changing it over from wake mode in which all the functions of the equipment are available thereby generating nominal electrical consumption, to sleep mode in which the equipment consumes relatively little power at the cost of reduced operating functions.

Conventionally the entering of communication equipment into standby mode is autonomous. The communication equipment follows internal procedure generally related to a timing system: when this communication equipment no longer receives messages or signals on one or more of its communication ports for a predetermined time it automatically sets itself in standby mode.

However, a problem is encountered when the local network to which the communication equipment belongs is composed of multiple links. More specifically, this problem is identified in the case when a data communication between terminal devices (typically from source equipment to receiving equipment in the local network) transits in one way or another via at least item of intermediate equipment.

FIG. 1 gives an example of a multi-link local network which illustrates this problem. It is a home local network composed of an Integrated Access Device of the type of those proposed by Internet Service Providers and commonly known as an IAD device, a Set-Top Box (STB) also supplied to customers by Internet service providers and which in particular offers IP television or video services on request, and a personal computer PC. These items of equipment are connected together via power line communication modems PLC1, PLC2, PLC3. In FIG. 1 the solid lines represent an Ethernet link whilst the dotted lines illustrate a power line communication link via the home electrical network. Communication is therefore possible between the modems PLC1 and PLC2 and between the modems PLC2 and PLC3. However, the conditions for signal propagation do not allow direct communication between the modems PLC1 and PLC3. To transmit data between the Integrated Access Device IAD and the personal computer PC, the signal is successively transmitted from modem PLC1 to modem PLC2, and then from modem PLC2 to modem PLC3, the modem PLC2 here acting as relay.

Some commercially available power line communication modems switch to standby mode as soon as their Ethernet port no longer receives or transmits any data for a predetermined length of time. Under nominal operation, the Integrated Access Device IAD transmits data to the multimedia Set-Top Box STB and to the personal computer PC. As soon as the multimedia Set-Top Box STB is no longer used and enters standby mode, its Ethernet port is no longer active and hence the modem PLC2 can be led to entering into standby mode. By so doing, it cuts off the communication that was hitherto available between the Integrated Access Device IAD and the PC. If data is transmitted between the Integrated Access Device IAD and the personal computer PC, it is then necessary to wait for waking of the PLC2 modem which will cause strong latency.

In general, the major disadvantage of the switching of equipment to standby mode in the prior art is that it is based on data on the activity of locally available connections at each equipment device, but in a network composed of multiple links the communication equipment may be part of several connections between terminal devices. As illustrated in FIG. 1, the switch to standby mode decided locally by one equipment device may cause this device to switch to standby although it still has a relay role to play for an active communication. The waking thereof will therefore bring about major latency.

One solution to bypass this problem is to use intermediate devices which never enter standby mode. Said solution is evidently unsatisfactory in terms of electrical consumption of the network.

### DESCRIPTION OF THE INVENTION

The invention proposes modifying the mechanism for placing communication equipment on standby, to overcome the shortcomings of the prior art.

For this purpose, the invention proposes a method for managing the switch to standby mode of communication equipment associated with a plurality of connections between terminal devices in a communication network, the method comprising the following steps:
detecting that one of the said connections changes over from active state wherein data is transmitted by means of said connection, to inactive state wherein no data is transmitted by means of the said connection;
maintaining the communication equipment in wake mode if at least one other of the said connections is in active state;
placing the communication equipment on standby if none of the said connections is in active state.

It is thereby ensured that all the connections with which a device is associated are inactive before this device switches to standby. This makes it possible to prevent the placing on standby of communication devices for as long as they have a role to play for an active communication, in particular a relay role, thereby avoiding strong latency which would be incurred through the necessary waking thereof.

In addition, compared with solutions consisting of using intermediate devices which never set themselves on standby, the mechanism for entering standby proposed by the invention enables the network to display improved energy efficiency. And if an equipment device is a source of radiation, the placing thereof on standby allows a reduction in the exposure of persons to electromagnetic waves.

Some preferred, but non-limiting, aspects of this method are the following:

The method may comprise the following steps:
memorising in a memory module at least one indication that one of said connections is in active state;
verifying, after detection of the changeover of one of said connections from active state to inactive state, whether or not the memory module contains an indication that another of the said connections is in active state, so as to apply maintained wake mode or to place the communication equipment in standby mode in relation to the presence of the said indication in the memory module.

These steps provide simple management of standby triggering or maintained wake mode of the equipment, via mere consulting of memorised data on active connections.

According to one embodiment, the indication that a connection is in active state may comprise an identifier of the said connection, the method after detection of the changeover of a connection from active state to inactive state comprising the deletion of the identifier of the said connection in the memory module. This provides for rapid decision-making through mere consulting of the presence or not of an active connection identifier in a memory module.

According to another embodiment the indication that a connection is in active state may comprise an identifier of the said connection associated with a status identifier of the said connection, the method after detection of the transitioning of a connection from active state to inactive state comprising the modification of the status identifier associated with the said connection in the memory model. This makes it possible to keep in memory the identifier of each of the connections which have become active to facilitate possible return to active state of one of these inactive connections.

The memorising of an indication that a connection is in active state may advantageously follow after detection of the changeover of the said connection from inactive state to active state, to allow the maintained updating of memorised data on active connections.

In one embodiment, the detection of changeover of one of said connections from active state to inactive state, or inactive state to active state respectively, may comprise the receiving of a standby triggering message, or wake message respectively, sent by one of the equipment devices concerned by the said connection. This makes it possible to cause a connection to change over from active state to inactive state or vice versa as soon as one of the devices of this connection changes status and signals change of status without the need to monitor data transmission on this connection.

In another embodiment, the detection of the changeover of one of the said connections from active state to inactive state or inactive state to active state respectively, comprises the detection of the absence, respectively presence, of data transmission on the said connection during an activity monitoring period, making it possible to manage standby triggering which does not require the use of additional signalling messages sent by the other equipment devices of this connection.

According to one embodiment, the detection of the changeover of one of the said connections from active state to inactive state and/or from inactive state to active state can be made in particular by the communication equipment. This allows for purely local and independent management of standby switching by the communication equipment itself.

Alternatively, the detection of the transitioning of one of the said connections from active state to inactive state and/or inactive state to active state can be detected by remote activity monitoring equipment, the method further comprising the transmission of an instruction message from said remote activity monitoring equipment sent to the communication equipment, the communication equipment being maintained in wake mode or placed on standby mode in relation to the said instruction message. The decision to maintain the communication equipment in wake mode or cause it to enter standby mode is thereby taken remotely for example by means of centralised equipment having full data on the respective activity statuses of the different connections within the communication network.

The invention is not limited to the standby management method presented in the foregoing but also extends to communication equipment able to be associated with a plurality of connections between terminal devices in a communication network, comprising a module for monitoring the activity of connections which, after detection that one of the said connections has transitioned from active state whereby data is transmitted on the said connection to inactive state whereby no data is transmitted on the said connection, is configured:
to maintain the communication equipment in wake mode if at least one of the said connections remains in active state;
to trigger standby mode of the communication equipment if none of the said connections is in active state.

This communication equipment may particularly comprise a memory module configured to memorise at least one indication that one of the said connections is in active state, the module for monitoring the activity of the connections then being also configured, further to detection of the changeover of one of said connections from active state to inactive state, to verify whether the memory module contains an indication that another of the said connections is in active state, so as to leave the communication equipment in wake mode or to place it on standby in relation to the presence of the said indication in the memory module.

According to one particular embodiment, the indication that one of the said connections is in active state comprises a connection identifier, optionally associated with a status identifier of the connection, in particular an ordered list of identifiers of devices belonging to the said connection, in an order ranging from a first equipment device called source equipment to a second equipment device called receiving equipment.

According to another embodiment, the module monitoring the activity of the connections is able to receive an instruction message from remote activity monitoring equipment and is configured to maintain the wake mode of the communication equipment or to place it on standby in relation to the said instruction message.

The invention also extends to a computer programme product comprising code instructions so that when this programme product is run by a processor of communication equipment, it is able to execute the standby management method presented above.

### BRIEF DESCRIPTION OF THE DRAWINGS

Other aspects, objectives and advantages of the present invention will become better apparent on reading the following detailed description of preferred embodiments thereof given as non-limiting examples and with reference to the appended drawings in which:

FIG. 1, already previously discussed, illustrates a multi-link home network; and

FIG. 2 illustrates the steps of a method for managing the standby switching of communication equipment according to one possible embodiment of the invention.

### DETAILED DESCRIPTION OF THE INVENTION

The invention concerns a method for managing the standby switching of communication equipment connected to a communication network, for example a LAN network, and in particular a multi-link network in which the equipment is associated with several connections between terminal devices of the network. In the particular case of a local or home network, by terminal device is meant any device capable of processing digital data and intended to be used by a user via a user interface, such as an Integrated Access Device of a home network, a Set-Top Box, a computer, a mobile telephone, a smartphone, a printer inter alia.

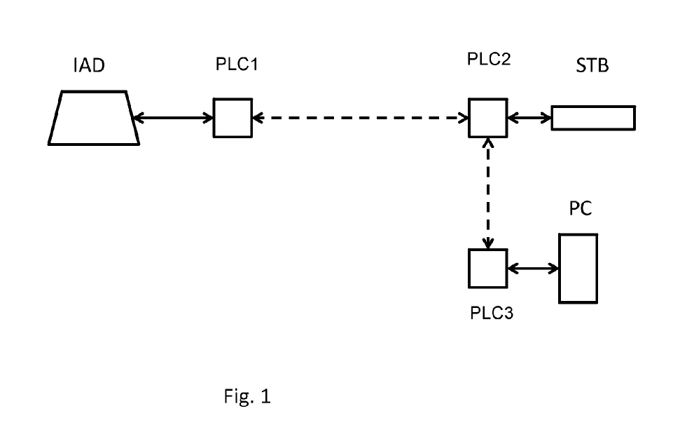

With further reference to FIG. 1 which illustrates an example of a said multi-link home network wherein the invention is implemented. The network here is formed of two connections between terminal devices:
a first connection “IAD-PLC1-PLC2-STB” connecting the Integrated Access Device IAD to the multimedia Set-Top Box STB via modems PLC1 and PLC2;
a second connection “IAD-PLC1-PLC2-PLC3-PC” connecting the Integrated Access Device IAD to the personal computer PC via the modems PLC1, PLC2 and PLC3.

Within the context of the present invention, a connection between terminal devices is defined by a first terminal device, called source equipment, a second terminal device called receiving equipment, and all the intermediate relay devices used so that the source equipment is able to communicate with the receiving equipment within the network.

A connection between terminal devices may in particular belong to a local communication network. For example in the network illustrated in FIG. 1, the terminal communication device formed by the Integrated Access Device IAD, and the relay communication devices formed by the modems PLC1 and PLC2 are associated with two different connections. In other words, two separate connections transit via these communication devices (the term “transit” applying both to relay devices and to terminal devices of this connection), these connections possibly being in active or inactive state independently of one another.

In the present description, a connection between terminal devices is thus determined as being initially in active state when data transmission is detected on this connection.

Conversely, a connection between terminal devices is determined as being in inactive state (i.e. changing over from active state to inactive state when this connection is initially considered to be active) when no data is transmitted by means of the said connection for a certain time, for example during an activity monitoring period which may be, as a non-limiting example, in the order of 1 minute.

According to the invention, it is the active or inactive state of a connection between terminal devices transiting via communication equipment which is considered before this communication equipment is placed on standby. When a connection between terminal devices is no longer active, the equipment that is part of this connection between terminal devices can only enter standby mode if it is not part of any other connection that is active within the network.

For this purpose, the placing on standby of communication equipment in this network is managed so as to detect whether or not a connection between terminal devices with which this equipment is associated transitions from active state to inactive state.

If such change of connection status is detected, the communication equipment is maintained in wake mode if at least one other of the connections between terminal devices transiting via this communication equipment is in active state.

If, on the other hand, none of the connections between terminal devices transiting via the communication equipment is in active state after detection of this change of status (which means that the connection which has become inactive was the last active connection transiting via this communication equipment), the communication equipment can be placed on standby.

To allow this detection, one embodiment entails the associating of a memory module with one or more items of communication equipment in the network for which the standby mode is to be managed, even all the communication equipment within the network, the memory module being used to memorise an indication that a connection is in active state for each of the active connections between terminal devices transiting via this communication equipment. In particular, this memory module can be installed in the communication equipment for which standby is to be managed e.g. in a communication relay PLC1 or PLC2.

As a variant, this memory module may be a module in equipment that is optionally separate from the communication equipment for which standby is to be managed within the network, this module possibly being called activity monitoring equipment e.g. a module of the Integrated Access Device IAD in the example shown FIG. 1, this activity monitoring equipment then acting as central coordinator for management of data on the activity statuses of the different connections between terminal devices of the network and for implementation of the method for managing standby switching of an item of equipment in the network.

Therefore, subsequent to detection of changeover to the inactive state of a connection between terminal equipment that is used by a device, it is verified whether or not the memory module contains an indication that another of the connections between terminal equipment also used by this device is in active state. If this is the case, the equipment is maintained in wake mode. If not the equipment is placed on standby.

In particular, the indication that a connection between terminal equipment that is used by the device is in active state may be an identifier of this connection. In this case, subsequent to detection of changeover to inactive state of this connection, the identifier of this connection is deleted in the memory module. The placing on standby of the communication equipment then only takes place when no connection identifier is memorised in the memory module.

As a variant, the indication that a connection between terminal equipment that is used by the device is in active state may be an identifier of this connection associated with a status identifier of this connection (“active” or “non-active”). In this latter case, further to detection of changeover of a connection to inactive state, the status identifier associated with this connection is modified accordingly in the memory module, without deleting the identifier of this connection, so as to maintain knowledge of already activated connections previously in memory, which may facilitate subsequent return to the active state of said inactive connection.

This is particularly useful when the communication equipment for which standby is to be managed receives messages to identify that a connection has become active or inactive sent by activity monitoring equipment. In such case it is not necessary to re-determine the list of equipment for a connection that is already memorised, which would require re-analysis of the messages received by the communication equipment to identify the equipment using this connection.

The identifier of a connection between terminal equipment can be represented in the memory module by a set of equipment identifiers grouping together an identifier for each of the items of equipment using the said connection, for example a set of addresses, in particular the Media Access Control (MAC) address of each device. The set of equipment identifiers can be represented in particular by an ordered list of identifiers listing all the equipment on which data transits, in order from the source equipment to the receiving equipment. It will be noted that in practice a connection between terminal devices is generally used for communication of two-directional data between source equipment and receiving equipment, which means that said connection can be represented in equivalent manner by a list of identifiers or the same list in reverse order.

Therefore returning to the example in FIG. 1 and using connection identifiers composed of ordered lists of equipment identifiers, the memory module associated with each device may therefore contain the following data when the two connections are active:

| | Identifiers of active connections |
|---|---|
| | between terminal devices used by |
| Equipment | the equipment |
| IAD | LB-PLC1-PLC2-STB |
| | LB-PLC1-PLC2-PLC3-PC |
| PLC1 | LB-PLC1-PLC2-STB |
| | LB-PLC1-PLC2-PLC3-PC |
| PLC2 | LB-PLC1-PLC2-STB |
| | LB-PLC1-PLC2-PLC3-PC |
| PLC3 | LB-PLC1-PLC2-PLC3-PC |
| STB | LB-PLC1-PLC2-STB |
| PC | LB-PLC1-PLC2-PLC3-PC |

In practice, in order to be able to manage switching to standby of communication equipment in the network, this network comprises a module monitoring the activity of connections that is configured, after detection that one of the connections used by this equipment changes over from active state to inactive state, so that it maintains this equipment in wake mode if at least one of these connections remains in active state or to trigger standby switching of this equipment if on the contrary none of these connections is in active state.

The module monitoring activity of the connections may further be configured to detect that a connection between terminals used by the equipment becomes active or inactive. This module then updates the memory module of the equipment, for example to delete therein the identifier of the connection that has become inactive, or on the contrary to add this identifier when this connection becomes active or to modify the status identifier of the connection.

If the communication equipment has a local memory module as described previously, the module monitoring the activity of connections is also configured so that, after detection of the changeover of one of the connections transiting via this equipment from active state to inactive state, it verifies whether the memory module contains an indication that another of the connections is in active state, so as to maintain the wake mode of the equipment or to place it on standby. Alternatively, it is central coordinating equipment that is in charge of updating the memory modules of the different devices within the network concerned by standby management.

Therefore when a new connection between terminal equipment, which is used by a device, becomes active the identifier of this new connection is added in the memory module associated with the communication equipment. A new active connection between terminals can be detected in particular through receipt of a message, for example a message transmitted by source equipment or a message transmitted by remote activity monitoring equipment.

In one embodiment, communication equipment detects the transmission of data via the connection for example during a period of activity monitoring. When a message is transmitted from source equipment to receiving equipment passing through one or more intermediate devices, the message necessarily contains a list of successive equipment identifiers for transmission. On receipt of such message, this equipment consults this list of identifiers and is able to memorise the same in its memory module if it is not already known. In another embodiment, an item of equipment for example the source equipment issues a connection establishment message to all equipment concerned giving information on the establishment of a new active connection between terminal equipment. It is a protocol message of MAC level for example.

In other embodiments in which recourse is had to remote monitoring equipment, this latter equipment may be notified of the receipt by a device in the network of a message transmitted by the source equipment, or it may directly receive a connection establishment message transmitted by the source equipment giving information on the establishment of a new connection. The remote activity monitoring equipment then transmits an instruction message to all devices concerned by the connection that has become active. The receipt of this instruction message enables the devices to detect the changeover of the connection from inactive state to active state.

The detection that a connection between terminal equipment has become inactive may comprise the detection of messages, for example a message transmitted by the source or a message transmitted by the remote activity monitoring equipment.

In particular, it is possible to detect the non-transmission of data on a connection during an activity monitoring period which may or may not be the same as the period for detection of the activity of a connection. In particular, each item of equipment can track the activity of a connection by verifying the occurrence of data frames transiting via this connection. When no packet is transmitted from the source equipment to receiving equipment on a certain connection during this activity monitoring period, this connection is deemed to be inactive. Standardisation of the lengths of the activity monitoring periods for all the devices in the network can be applied to avoid inconsistencies between data memorised in the different memory modules associated with the different devices.

In another embodiment, the source equipment or connectivity receiving equipment, for example when it enters standby, sends to all equipment concerned a connection break message giving information on the changeover to inactive mode of the said connectivity. It is a protocol message of MAC level for example. In other embodiments, in which recourse is had to remote activity monitoring equipment, this latter equipment can be informed of the detection by a device in the network of the absence of data transiting on a connection, or it may directly receive a connection break message transmitted by the source equipment or receiving equipment. The remote activity monitoring equipment then transmits an instruction message to all the devices concerned by the connection that has become inactive. The receipt of this instruction message enables these devices to detect the changeover of the connection from active state to inactive state.

One application of the invention to the network in FIG. 1 may be as follows. It will be noted that the example is used here of the recourse to protocol messages presented above, but evidently the same result would be obtained if the other embodiments presented above were applied.

If the multimedia Set-Top Box STB switches to standby, it sends a message to the modems PLC2, PLC1 and to the Integrated Access Device IAD informing them that the first connection “LB-PLC1-PLC2-STB” has become inactive. Since these three items of equipment are all part of another active connection, they do not enter standby at this stage.

If, on the other hand, it is the personal computer PC which enters standby, it sends a message to the modems PLC3, PLC2, PLC1 and to the Integrated Access Device IAD informing them that the connection “LB-PLC1-PLC2-PLC3-PC” has become inactive. The memory module associated with the modem PLC3 is then updated, for example to delete therein the identifier of this connection. Since the memory module no longer contains any entry corresponding to an active connection, the modem PLC3 can be set on standby.

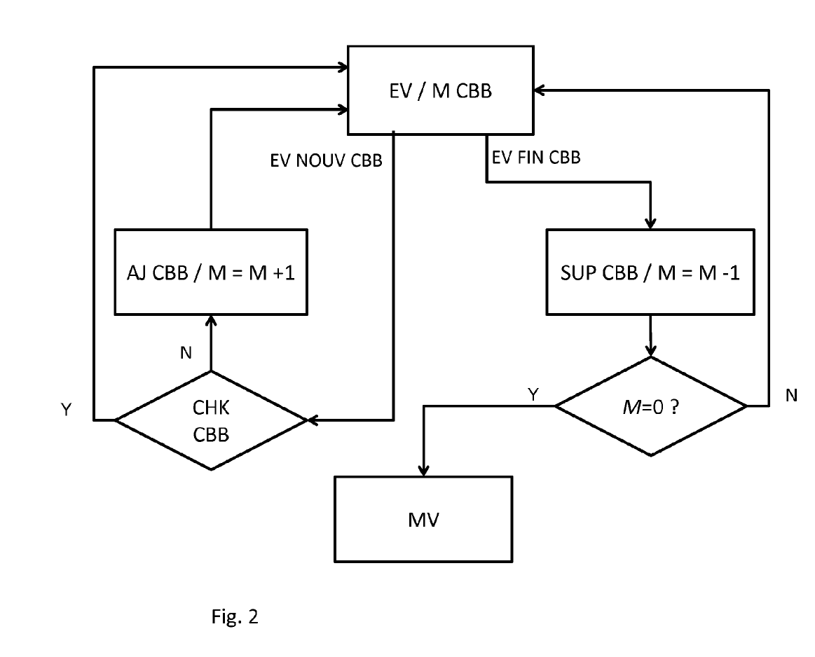

FIG. 2 gives a decision diagram illustrating one possible implementation of the invention by communication equipment in the network for which the standby mode is managed according to the method of the present invention.

In a first state “EV/M CBB” this communication equipment is in wake mode and shares M active connections between terminal devices of the network.

The event “EV/FIN CBB” means that one connection between terminal devices that is used by this equipment has become inactive. After detection of said event “EV FIN CBB” (either by the equipment itself or by a separate activity monitoring equipment) operation “SUP CBB/M=M−1” is performed whereby the identifier of the connection which has become inactive is deleted from the memory module of the equipment, the number M of active connections being reduced by one unit.

Further to detection of the event “EV FIN CBB” and to the deletion operation “SUP CBB/M=M−1”, an operation “M=0?” is performed whereby it is verified whether or not the memory module contains an indication that another of the connections used by this equipment is in active state.

If the memory module contains a said indication (case “N”) the equipment remains in wake mode “EV/M CBB”.

If, on the other hand, the memory module does not contain a said indication (case “0”) the equipment is switched to standby and changes over to state “MV”. Before setting itself on standby the equipment transmits a connection break message to all the devices belonging to the said connection(s) used by the said equipment to inform them thereof.

In another configuration, starting from the first state “EV/M CBB”, the event “EV NOUV CBB” means that a connection between terminal devices that is used by the equipment for which standby is to be managed, has been activated.

It is then possible to verify during an operation “CHK CBB” whether or not an identifier of this connection is memorised in the memory module of the communication equipment for which standby mode is to be managed.

If such is already the case (case “O”), this equipment remains in the first state “EV/M CBB” in which it is in wake mode and concerned by M active connections. If this is not the case (case “N”), operation “AJ CBB/M=M+1” is carried out whereby the identifier of the new active connection is memorised in the memory module, and the number M of active connections is increased by one unit. This is followed by re-looping onto the first state “EV/M CBB”.

It will have been understood that advantageously, compared with the prior art, the invention avoids the placing on standby of communication equipment if it still has a role to play for active communication, in particular as repeater, thereby preventing strong latency which would be caused by their waking. This applies both to communication relay equipment of power line communication modem type, and to terminal communication equipment intended to make use of several connections in parallel such as an Integrated Access Device for example.

Also, at the present time the electric consumption of some equipment represents a major part of the total consumption of the local network since it remains constantly switched on for lack of a suitable, coordinated standby switching mechanism. The invention therefore allows substantial savings in the electric consumption of network equipment.

The invention also finds application in a network composed of links using multiple technologies. Modems are known used to extend Wi-Fi wireless coverage in a home. Such equipment receives data via a power line communication link and retransmits the data via a WiFi link. In substance a said modem can be used as Integrated Access Device for several laptop computers. By implementing the invention, the modem remains in wake mode for as long as it acts as connection relay towards a least one laptop computer. As soon as all the laptop computers enter standby, the modem also switches to standby. The invention therefore not only improves the energy efficiency of the network but also stops radiation of the Wi-Fi modem when it is no longer needed, which reduces exposure of persons to electromagnetic waves.

Additionally, the invention is not limited to the method such as previously described but also extends to communication equipment able to be associated with a plurality of connections between terminal devices of a communication network.

This equipment then comprises a module for monitoring the activity of connections that is configured so that, after detection that one of said connections has changed over from active state to inactive state, it maintains the communication equipment in wake mode if at least one of the abovementioned connections remains in active state, or on the contrary triggers the switching to standby of the communication equipment if none of the above-mentioned connections is in active state.

This activity monitoring module can be configured so that it is itself able to detect the changeover to inactive state of one of these connections, by monitoring the transmission of data on this connection during an activity monitoring period of determined duration, or alternatively it may receive a message from another device in the network indicating the changeover to inactive state of this connection.

Said activity monitoring module can be particularly implemented in the form of a processor able to execute code instructions of a computer programme to apply the steps of the method described in the foregoing.

As indicated previously, said communication equipment may further comprise a memory module capable of storing indications on the active state of connections transiting via this equipment, in the form of an identifier of each of these connections as such or in the form of an identifier of each of these connections associated with an identifier of the activity status of the connection under consideration. Said memory module may also take on the form of a RAM-type memory associated with the above-mentioned processor within a processing unit integrated in the communication equipment for which standby switching is to be managed.

The invention also concerns a communication network comprising one or more of the above-mentioned devices. It also concerns a computer programme comprising code instructions so that, when this programme product is run by a processor of communication equipment, it can execute the method for standby switching described in the foregoing. It also concerns a recording medium on which said computer programme is stored.

1. A method for managing the standby switching of communication equipment associated with a plurality of connections between terminal devices in a communication network,
the method comprising the:
detecting that one of said connections changes over from an active state in which data is transmitted by means of the said connection, to an inactive state in which no data is transmitted by means of the said connection;
maintaining the communication equipment in wake mode if at least one other of the said connections is in said active state;
placing on standby the communication equipment if none of the said connections is in said active state.

2. The method according to claim 1, further comprising:
memorizing in a memory module at least one indication that one of said connections is in said active state;
verifying, further to the detected transitioning of one of said connections from said active state to said inactive state, whether the memory module contains an indication that one other of the said connections is in said active state, so as to apply maintained wake mode or the placing on standby of the communication equipment in relation to the presence of the said indication in the memory module.

3. The method according to claim 2, wherein the indication that one of the said connections is in said active state comprises an identifier of the said connection, the method after detection of the changeover of a connection from said active state to said inactive state, comprising the deletion of the identifier of the said connection in the memory module.

4. The method according to claim 2, wherein the indication that one of the said connections is in said active state comprises an identifier of the said connection associated with a status identifier of the said connection, the method further to detection of the changeover of a connection from said active state to said inactive state comprising the modification of the status identifier associated with the said connection in the memory module.

5. The method according to claim 1, wherein the memorizing of an indication that one of said connections is in said active state follows after the detection of the changeover of the said connection from said inactive state to said active state.

6. The method according to claim 1, wherein the detection of the changeover of one of said connections from said active state to said inactive state, respectively from said inactive state to said active state, comprises the receiving of a connection break message, respectively connection establishment message, sent by one of the devices sharing this connection.

7. The method according to claim 1, wherein the detection of the changeover of one of said connections from said active state to said inactive state, respectively from said inactive state to said active state comprises the detection of the absence respectively presence of data transmission on the said connection during an activity monitoring period.

8. The method according to claim 1, wherein the detection of the changeover of one of said connections from said active state to said inactive state and/or from said inactive state to said active state is detected by the communication equipment.

9. The method according to claim 1, wherein the detection of the changeover of one of said connections from said active state to said inactive state and/or from said inactive state to said active state is detected by remote activity monitoring equipment, the method further comprising the transmission of an instruction message from said remote activity monitoring equipment to the communication equipment, the communication equipment being maintained in wake mode or placed on standby in relation to the said instruction message.

10. Communication equipment able to be associated with a plurality of connections between terminal devices in a communication network, comprising a module monitoring the activity of the connections that is configured, after detection that one of said connections has transitioned from an active state in which data is transmitted by the said connection to an inactive state in which no data is transmitted by the said connection:
to maintain the communication equipment in wake mode if one of the said connections remains in said active state;
to trigger standby mode of the communication equipment if none of said connections is in said active state.

11. The communication equipment according to claim 10, wherein the module monitoring connection activity is also configured to detect when one of said connections changes over from said active state to said inactive state.

12. The communication equipment according to claim 11, further comprising a memory module configured to memorize at least one indication that one of said connections is in said active state,
the module monitoring connection activity also being configured, after detection of changeover of one of said connections from said active state to said inactive state, to verify whether the memory module contains an indication that one other of the said connections is in said active state, so as to apply maintained wake mode or the switching to standby of the communication equipment in relation to the presence of the said indication in the memory module.

13. The communication equipment according to claim 12, wherein the indication that one of said connections is in said active state comprises a connection identifier, optionally associated with a status identifier of the connection in an order ranging from a first device called source equipment to a second device called receiving equipment.

14. The communication equipment according to claim 10, wherein the module monitoring connection activity is able to receive an instruction message from remote activity monitoring equipment and is configured to maintain the communication equipment in wake mode or to place it on standby in relation to the said instruction message.

15. A computer program product comprising code instructions so that when this program product is run on a processor of communication equipment it can execute the method according to claim 1.

16. The communication equipment of claim 13, wherein said connection identifier is associated with a status identifier of the connection.

17. The communication equipment of claim 14, wherein said status identifier of the connection comprises an ordered list of identifiers of devices belonging to the said connection.
